(19) United States
(12) Patent Application Publication
(10) Pub. No.: US 2020/0095655 A1
(43) Pub. Date: Mar. 26, 2020

(54) AS-CAST HIGH STRENGTH NODULAR IRON WITH FAVORABLE MACHINABILITY

(71) Applicant: GM GLOBAL TECHNOLOGY OPERATIONS LLC, DETROIT, MI (US)

(72) Inventors: Jianghuai Yang, Rochester Hills, MI (US); James D. Cremonesi, Rochester Hills, MI (US); Qigui Wang, Rochester Hills, MI (US); Eduardo Velasco Orosco, Toluca (MX); Dale A. Gerard, Bloomfield Hills, MI (US)

(21) Appl. No.: 16/136,445

(22) Filed: Sep. 20, 2018

(51) Int. Cl. C22C 37/10; C22C 37/06

(52) U.S. Cl. CPC C22C 37/10; F16C 3/06; C22C 37/06

(57) ABSTRACT

A nodular iron alloy and automotive components, such as crankshafts, are provided. The nodular iron alloy may include iron, about 3.3-3.9 wt % carbon, about 0.2-0.5 wt % manganese, about 1.9-2.6 wt % silicon, about 0.15-0.30 wt % copper, about 0.03-0.06 wt % magnesium, about 0-0.02 wt % sulfur, about 0-0.1 wt % chromium, about 0-0.05 wt % phosphorus, and/or about 0-0.01 wt % tin. The nodular iron alloy may include a number of graphite nodules, each having a diameter between 15 and 120 micrometers, and the graphite nodules having a number density of at least 90 per square millimeter. Iron may surround the graphite nodules in an amount of 20-40% of a ferrite microstructure and 60-80% of a pearlite microstructure. The nodular iron alloy may have an ultimate tensile strength in the range of 550 MPa to 680 MPa as-cast and at least 80% nodularity.

### FIELD

The present disclosure relates generally to iron alloys, and more particularly, to iron alloys that are nodular and have a desired strength as-cast for machinability, as well as components made therefrom, such as crankshafts, flywheels, and transmission shafts.

### INTRODUCTION

Typical nodular iron used in crankshafts is provided from a foundry having an ultimate tensile strength of about 700-800 MPa and an iron or iron alloy portion of the microstructure containing 5-10% ferrite and the balance pearlite. Such nodular iron or nodular iron alloys meet strength requirements for crankshafts, but they are very difficult to machine and any machining that is performed produces residual stress. To abate these issues, sub-critical annealing is performed to reduce the ultimate tensile strength of the nodular iron, resulting in a reduction in ultimate tensile strength of approximately 17%. However, sub-critical annealing adds extra time and cost and imparts potential material handling issues.

### SUMMARY

This disclosure provides a new nodular iron alloy that has a desirable strength and which is machinable as-cast. The new nodular iron alloy may have, for example, an ultimate tensile strength in the range of 550-680 MPa, or 620+/−3 Sigma max, where Sigma=18-22 MPa, as-cast and with the iron having a 20-40% ferrite microstructure.

In one example, which may be combined with or separate from the other examples and features provided herein, a nodular iron alloy is provided containing: iron; carbon; silicon; about 0.2 to about 0.5 weight percent manganese; and about 0.15 to about 0.30 weight percent copper.

In another example, which may be combined with or separate from the other examples provided herein, a nodular iron alloy is provided that consists essentially of: about 3.3 to about 3.9 weight percent carbon; about 1.9 to about 2.6 weight percent silicon; about 0.2 to about 0.5 weight percent manganese; about 0.15 to about 0.30 weight percent copper; about 0.03 to about 0.06 weight percent magnesium; 0 to about 0.05 weight percent phosphorus; 0 to about 0.02 weight percent sulfur; 0 to about 0.01 weight percent tin; 0 to about 0.1 weight percent chromium; and the balance iron.

In yet another example, which may be combined with or separate from the other examples provided herein, a nodular iron alloy is provided that contains: a plurality of graphite nodules and iron surrounding the plurality of graphite nodules. Each graphite nodule has a diameter between 15 and 120 micrometers, and the plurality of graphite nodules have a number density of at least 90 nodules per square millimeter. The iron is present in an amount of 20-40% of a ferrite microstructure and in an amount of 60-80% of a pearlite microstructure. The nodular iron alloy has an ultimate tensile strength in the range of 550 MPa to 680 MPa as-cast (or 620+/−3 Sigma max, where Sigma=18-22 MPa, as-cast) and at least 80% nodularity.

Additional features may be provided, including but not limited to the following: wherein the iron is provided in an amount of at least 92.5 weight percent; wherein the carbon is provided in an amount of about 3.3 to about 3.9 weight percent; wherein the silicon is provided in an amount of about 1.9 to about 2.6 weight percent; the nodular iron alloy further comprising about 0.03 to about 0.06 weight percent magnesium; the nodular iron alloy further comprising tin in an amount not exceeding 0.01 weight percent; the nodular iron alloy further comprising chromium in an amount not exceeding 0.1 weight percent; the nodular iron alloy further comprising phosphorus in an amount not exceeding 0.05 weight percent; the nodular iron alloy further comprising sulfur in an amount not exceeding 0.02 weight percent; wherein the nodular iron alloy has an ultimate tensile strength in the range of 550 MPa to 680 MPa as-cast; wherein the nodular iron alloy has an ultimate tensile strength of 620+/−3 Sigma max, where Sigma=18-22 MPa, as-cast; wherein the iron is present in an amount of 20-40% of a ferrite microstructure and in an amount of 60-80% of a pearlite microstructure; wherein the iron surrounds a number of graphite nodules; the nodular iron alloy having at least 80% nodularity; wherein a substantial majority of the graphite nodules have a diameter between 6 and 60 micrometers; and wherein the graphite nodules have a number density of at least 90 nodules per square millimeter.

Further additional features may be included, including but not limited to the following: an automotive component being created from any variation of the nodular iron alloy; and the automotive component being a crankshaft, a transmission shaft, a transmission case, a differential carrier, a half shaft, or an axle shaft.

The above features and advantages, and other features and advantages of the present disclosure, will be readily apparent from the following detailed description of the many aspects of the present disclosure when taken in connection with the accompanying drawings and appended claims.

### BRIEF DESCRIPTION OF THE DRAWINGS

The drawings are provided for illustration purposes only and are not intended to limit this disclosure or the claims appended hereto.

FIG. 1 is an enlarged view of a prior art nodular iron alloy illustrating the microstructure thereof;

FIG. 2 is an enlarged view of a nodular iron alloy illustrating the microstructure thereof, in accordance with the principles of the present disclosure; and

FIG. 3 is a perspective view of a crankshaft formed of a nodular iron alloy in accordance with the principles of the present disclosure.

### DETAILED DESCRIPTION

Nodular ductile iron alloys having as-cast desirable strength and machinability are provided. These nodular iron alloys are particularly useful for cast automotive components that undergo large loads, fatigue, and a significant amount of machining operations. The automotive components may be implemented as cast, which saves on additional steps and costs. As a result, the conventional annealing process can be eliminated, if desired.

The nodular iron alloys disclosed herein contain iron, carbon, silicon, and manganese, and the nodular iron alloys may also contain phosphorus, sulfur, copper, tin, chromium, and magnesium.

The nodular iron alloys disclosed herein may include iron, carbon, silicon, and by weight about 0.2 to about 0.5 weight percent (or exactly 0.2-0.5 wt %) manganese and about 0.15 to about 0.30 weight percent (or exactly 0.15-0.30 wt %) copper. The iron may be provided in an amount of at least 92.5 weight percent; the carbon may be provided in an amount of about 3.3 to about 3.9 weight percent (or exactly 3.3-3.9 wt %); and the silicon may be provided in an amount of about 1.9 to about 2.6 weight percent (or exactly 1.9-2.6 wt %). The nodular iron alloys may also include one or more of the following: about 0.03 to about 0.06 weight percent (or exactly 0.03-0.06 wt %) magnesium; tin in an amount not exceeding 0.01 weight percent; chromium in an amount not exceeding 0.1 weight percent; phosphorus in an amount not exceeding 0.05 weight percent; and sulfur in an amount not exceeding 0.02 weight percent. For example, Table 1 shows an example of the nodular iron alloy, which contains iron, carbon, silicon, manganese, copper, and magnesium, and which may also contain phosphorus, sulfur, tin, and chromium. The iron may be provided in an amount of at least 92.5 weight percent.

TABLE 1
Example of a New Nodular Iron Alloy

| C | Si | Mn | P | S | Cu | Sn | Cr | Mg | |
|---|---|---|---|---|---|---|---|---|---|
| (wt %) | (wt %) | (wt %) | (wt %) | (wt %) | (wt %) | (wt %) | (wt %) | (wt %) | Fe |
| 3.3-3.9 | 1.9-2.6 | 0.2-0.5 | 0-0.05 | 0-0.02 | 0.15-0.30 | 0-0.01 | 0-0.1 | 0.03-0.06 | Balance |

It should be understood that the new nodular iron alloy can have any combination of the listed elements above in Table 1, and need not include all of them.

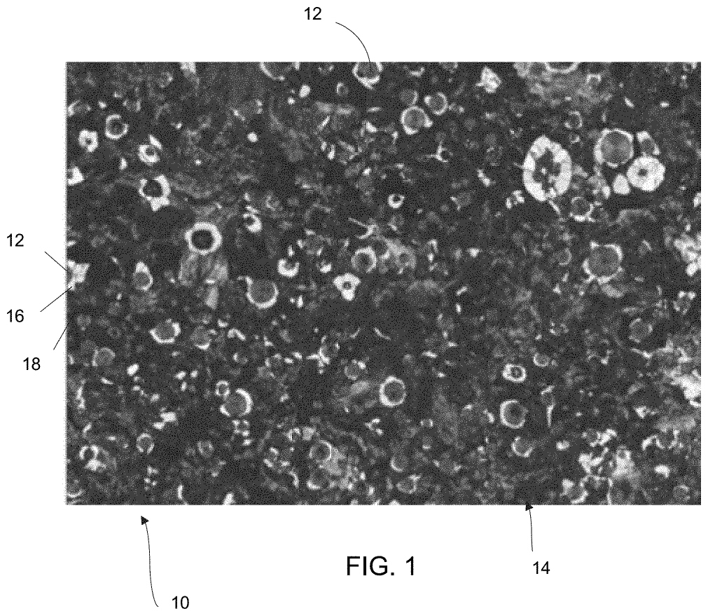

Referring now to FIG. 1, a prior art nodular iron 10 is illustrated having a microstructure developed from a composition different from that in Table 1. A plurality of graphite nodules 12 are present with only 5-10% of the iron 14 surrounding the graphite nodules 12 having a ferrite microstructure. The ferrite microstructure 16 is disposed directly adjacent to the nodules 12, and pearlite microstructure 18 surrounds the ferrite microstructure 16. The ferrite microstructure 16 appears lighter than the pearlite microstructure 18 in FIG. 1, upon a regular etching procedure for metallographic characterization. The prior art nodular iron 10 may have an ultimate tensile strength, for example, in the range of 700-800 MPa, or higher, as-cast, which is so strong that machining the nodular iron 10 is very difficult. Accordingly, further procedures, such as annealing may be performed on the nodular iron 10 to reduce the ultimate tensile strength enough to machine the nodular iron 10.

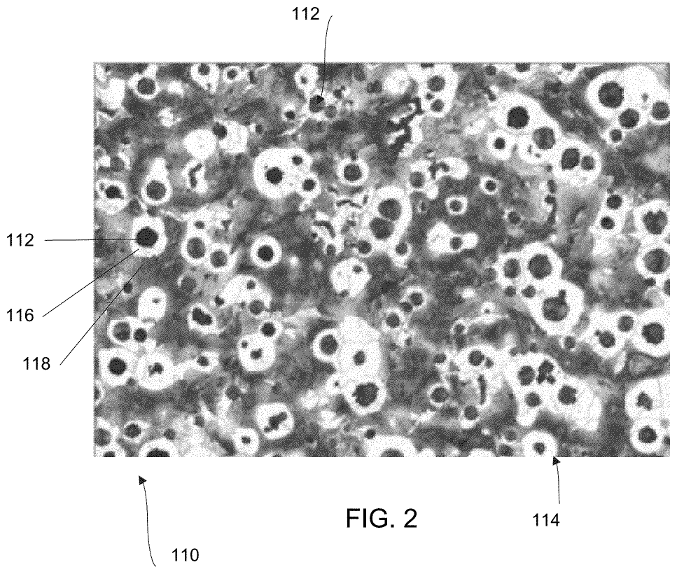

Referring now to FIG. 2, a nodular iron 110 in accordance with the principles of the present disclosure is illustrated. The nodular iron 110 may have a composition, for example, with element ranges shown in Table 1. Again, a plurality of graphite nodules 112 are present, but a much greater amount of ferrite microstructure 116 is present surrounding the graphite nodules 112. In this case, about 20-40% of the iron 114 surrounding the graphite nodules 112 has a ferrite microstructure 116, and about 60-80% of the iron 114 surrounding the graphite nodules 112 has a pearlite microstructure 118. In some cases, such as illustrated in FIG. 2, the ferrite microstructure 116 may be present in an amount of about 25-30% of the total amount of iron 114. The ferrite microstructure 116 is disposed directly adjacent to the nodules 112, and the pearlite microstructure 118 surrounds the ferrite microstructure 116, such that the ferrite microstructure 116 is disposed between the nodules 112 and the pearlite microstructure 118. As in FIG. 1, the ferrite microstructure 116 appears lighter than the pearlite microstructure 118 in FIG. 2, upon a regular etching procedure for metallographic characterization.

The nodular iron 110 may have an ultimate tensile strength, for example, in the range of 550-680 MPa as-cast. The nodular iron 110 may also or alternatively be described as having an ultimate tensile strength of 620+/−3 Sigma max, where Sigma=18-22 MPa, as-cast. Accordingly, the nodular iron 110 has sufficient strength for use in high-load automotive components, such as crankshafts, as-cast, but does not have excessive strength that causes machinability issues. The nodular iron 110 may have at least 80% nodularity, and in some cases, at least 90% nodularity. A substantial majority of, or all of, the graphite nodules 112 have a diameter between 15 and 60 micrometers, with fewer nodules up to 120 micrometers, resulting in a nodule size of 5-7 per ISO standard. The graphite nodules 112 may have a number density of at least 90 nodules per square millimeter.

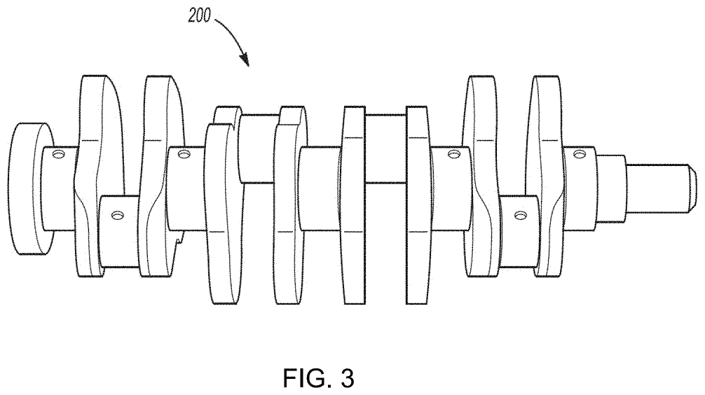

The nodular iron alloys described herein may be used to manufacture an automotive component, which may be, in some cases, a cast automotive propulsion system component. Therefore, it is within the contemplation of the inventors herein that the disclosure extends to automotive components, including but not limited to crankshafts, transmission shafts, transmission cases, differential carriers, half shafts, axle shafts, and the like. For example, referring to FIG. 3, a crankshaft 200 is illustrated, which is made of any variation of the nodular iron alloy described herein, and which may be cast.

Furthermore, while the above examples are described individually, it will be understood by one of skill in the art having the benefit of this disclosure that amounts of elements described herein may be mixed and matched from the various examples within the scope of the appended claims. It is further understood that any of the above described concepts can be used alone or in combination with any or all of the other above described concepts.

What is claimed is:

1. A nodular iron alloy comprising:
iron;
carbon;
silicon;
about 0.2 to about 0.5 weight percent manganese; and
about 0.15 to about 0.30 weight percent copper.

2. The nodular iron alloy of claim 1, wherein the iron is provided in an amount of at least 92.5 weight percent.

3. The nodular iron alloy of claim 2, wherein the carbon is provided in an amount of about 3.3 to about 3.9 weight percent.

4. The nodular iron alloy of claim 3, wherein the silicon is provided in an amount of about 1.9 to about 2.6 weight percent.

5. The nodular iron alloy of claim 4, further comprising about 0.03 to about 0.06 weight percent magnesium.

6. The nodular iron alloy of claim 5, further comprising tin in an amount not exceeding 0.01 weight percent.

7. The nodular iron alloy of claim 6, further comprising:
chromium in an amount not exceeding 0.1 weight percent;
phosphorus in an amount not exceeding 0.05 weight percent; and
sulfur in an amount not exceeding 0.02 weight percent.

8. The nodular iron alloy of claim 5, wherein the nodular iron alloy has an ultimate tensile strength in the range of 550 MPa to 680 MPa as-cast.

9. The nodular iron alloy of claim 8, wherein the iron is present in an amount of 20-40% of a ferrite microstructure and in an amount of 60-80% of a pearlite microstructure, wherein the iron surrounds a plurality of graphite nodules.

10. The nodular iron alloy of claim 9, the nodular iron alloy having at least 80% nodularity.

11. The nodular iron alloy of claim 10, wherein a substantial majority of the plurality of graphite nodules each have a diameter between 15 and 120 micrometers.

12. The nodular iron alloy of claim 11, wherein the plurality of graphite nodules have a number density of at least 90 graphite nodules per square millimeter.

13. An automotive component created from a nodular alloy according to claim 5.

14. The automotive component of claim 13, wherein the automotive component is one of a crankshaft, a transmission shaft, a transmission case, a differential carrier, a half shaft, and an axle shaft.

15. A crankshaft created from a nodular iron alloy according to claim 1.

16. A nodular iron alloy consisting essentially of:
about 3.3 to about 3.9 weight percent carbon;
about 1.9 to about 2.6 weight percent silicon;
about 0.2 to about 0.5 weight percent manganese;
about 0.15 to about 0.30 weight percent copper;
about 0.03 to about 0.06 weight percent magnesium;
0 to about 0.05 weight percent phosphorus;
0 to about 0.02 weight percent sulfur;
0 to about 0.01 weight percent tin;
0 to about 0.1 weight percent chromium; and
the balance iron.

17. The nodular iron alloy of claim 16, wherein the nodular iron alloy has an ultimate tensile strength in the range of 550 MPa to 680 MPa as-cast, wherein the iron is present in an amount of 20-40% of a ferrite microstructure and in an amount of 60-80% of a pearlite microstructure, and wherein the iron surrounds a plurality of graphite nodules.

18. An automotive component created from a nodular iron alloy according to claim 16.

19. A nodular iron alloy comprising:
a plurality of graphite nodules, each graphite nodule having a diameter between 15 and 60 micrometers, the plurality of graphite nodules having a number density of at least 90 graphite nodules per square millimeter; and
iron present in an amount of 20-40% of a ferrite microstructure and in an amount of 60-80% of a pearlite microstructure, wherein the iron surrounds the plurality of graphite nodules, the nodular iron alloy having an ultimate tensile strength in the range of 550 MPa to 680 MPa as-cast, and the nodular iron alloy having at least 80% nodularity.

20. An automotive component created from a nodular iron alloy according to claim 19.
